(19) United States
(12) Patent Application Publication
(10) Pub. No.: US 2007/0243300 A1
(43) Pub. Date: Oct. 18, 2007

(54) Method for Making a Fruit Pastry Bar

(75) Inventor: Daniel Peyrat, Champigny (FR)

Correspondence Address: CONNOLLY BOVE LODGE & HUTZ LLP;(FOR CABINET BEAU DE LOMENIE), P.O. BOX 2207, WILMINGTON, DE, 19899-2207, US

(73) Assignee: Carre Gourmet Diffusion, Valenton (FR)

(21) Appl. No.: 10/587,259

(22) PCT Filed: Jan. 25, 2005
(86) PCT No.: PCT/FR05/00160

§ 371 Date: Mar. 9, 2007

(30) Foreign Application Priority Data
Jan. 26, 2004 (FR) 0400691

(51) Int. Cl. A21D 13/08

(52) U.S. Cl. 426/556

(57) ABSTRACT

The method comprises the steps consisting in: lining a mold (30) of elongate shape and substantially U-shaped section with a pastry dough (50) covering the bottom of the mold and its side walls over a fraction only of their height up from the bottom, pouring a confectioner's mix (58) onto the dough, covering the dough and the confectioner's mix with a trimming of fruit or pieces of fruit (62) mixed with a gelling composition by pouring the trimming into the mold up to the top thereof, and baking the dough and the confectioner's mix with the trimming in the mold.

### FIELD OF THE INVENTION

The invention seeks to provide a method for use, in particular on an industrial scale, in making a fruit pastry in the form of a bar, and more particularly a pastry in the form of an individual portion.

Consumers are very fond of individual-portion fruit pastries, typically such as little round tarts. Fruit pastries having some other shape, and more particularly in the form of a bar can be advantageous: they are easy to hold in the hand, like a candy bar, and they are easy to store. They lend themselves well to being used in fast-food outlets or in canteens, but nevertheless they are not restricted to that field of application only.

In any event, making fruit pastries in the form of a bar raises certain difficulties, particularly if it is desired to limit the relative quantity of pastry. Particularly for pastry in individual portions, it is not conceivable to form a rim of pastry surrounding the fruit over the full height of the bar, since the quantity of pastry compared to the quantity of fruit would then be excessive. This leads to a problem of adequate strength and of the pastry retaining its bar shape.

### OBJECT AND SUMMARY OF THE INVENTION

An object of the invention is to provide a method of making such a pastry that is suitable for implementing on an industrial scale with low manufacturing costs, while obtaining a product that is attractive in terms of appearance, texture, and taste.

According to the invention, this object is achieved by a method comprising the steps consisting in:
lining a mold of elongate shape and substantially U-shaped section with a pastry dough covering the bottom of the mold and its side walls over a fraction only of their height up from the bottom;
pouring a confectioner's mix onto the dough;
covering the dough and the confectioner's mix with a trimming of fruit or pieces of fruit mixed with a gelling composition by pouring the trimming into the mold up to the top thereof; and
baking the pastry and the covered confectioner's mix in the mold.

The confectioner's mix used may be constituted, amongst other things, by an optionally-foamed confectionery filling or traditional almond cream. For the gelling composition, it is possible to use a composition containing brown sugar and pectin.

Advantageously, a single-use mold is used such as a mold made of card or of aluminum.

Also advantageously, the trimming of fruit or pieces of fruit is applied automatically by means of a feeder. Compared with manual trimming, this avoids the fruit being handled and can reduce manufacturing costs.

Prior to trimming with fruit and pieces of fruit, it is possible to pre-bake the pastry and the confectioner's mix. The pre-baking is performed, for example, so as to reach a baking level corresponding to 50% to 85% approximately of complete baking. The term “baking level” is used to mean in particular the level of dehydration. The baking step then serves not only to complete baking, but also to impart an attractive appearance to the fruit or pieces of fruit.

The mold is preferably lined with pastry dough so as to cover the side walls of the mold up to a height lying in the range ¼th to ⅔rds the height of said walls.

After baking, the resulting pastry can be deep-frozen and packaged.

When pre-baking is performed, deep-freezing may take place after the pre-baking, possibly after the pre-baked pastry and confectioner's mix has received the trimming, but prior to final baking, which can be performed immediately before the pastry is consumed.

The invention also provides a pastry as obtained by the above method, i.e. a pastry comprising a tartlet having a rectangular bottom with longitudinal and end margins, a confectioner's mix covering the bottom of the tartlet, and fruit or pieces of fruit held by a gelled composition forming a trimming on the top of the tartlet and extending above the margins thereof, while substantially reproducing the external rectangular profile of the tartlet.

The pastry may be packaged in its single-use baking mold, e.g. made of aluminum or card.

### BRIEF DESCRIPTION OF THE DRAWINGS

In the detailed description below, reference is made to the accompanying drawings, in which:

FIG. 1 shows the successive steps of an implementation of the method of the invention;

FIG. 2 shows the successive steps of another implementation of the method in accordance with the invention;

FIG. 3 is a section view showing diagrammatically the step of applying trimming in the form of pieces of fruit when implementing the method of FIG. 1;

FIG. 4 is a partially cutaway diagrammatic view of a pastry obtained by a method such as the method of FIG. 1, the pastry being packaged in its baking mold; and

FIG. 5 is a photograph of a pastry made in accordance with the invention.

### DETAILED DESCRIPTION OF EMBODIMENTS OF THE INVENTION

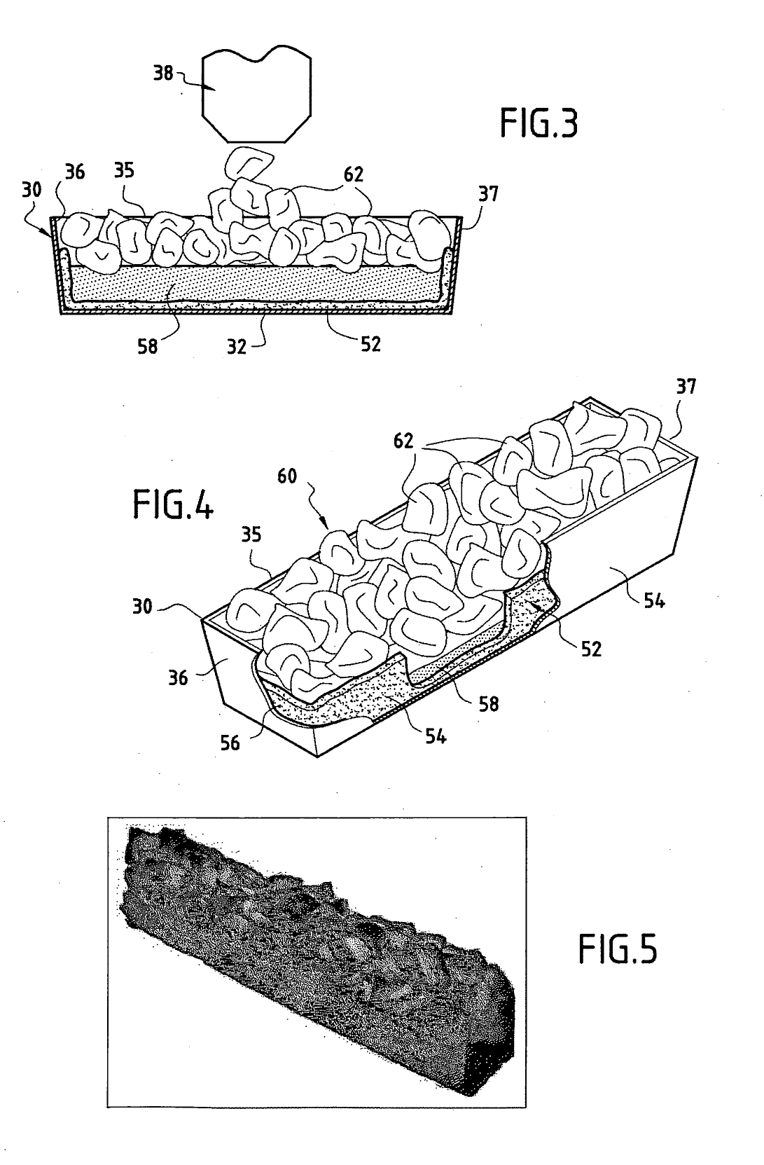

A pastry in accordance with the invention is prepared in a mold 30 of generally rectangular shape and U-shaped sections (see FIGS. 3 and 4), the shape and the dimensions of the mold being selected as a function of the shape and the dimensions of the pastry to be made. Advantageously, a single-use mold is used, e.g. a mold made of aluminum or card, having a bottom 32, longitudinal walls 34, 35, and end walls 36, 37.

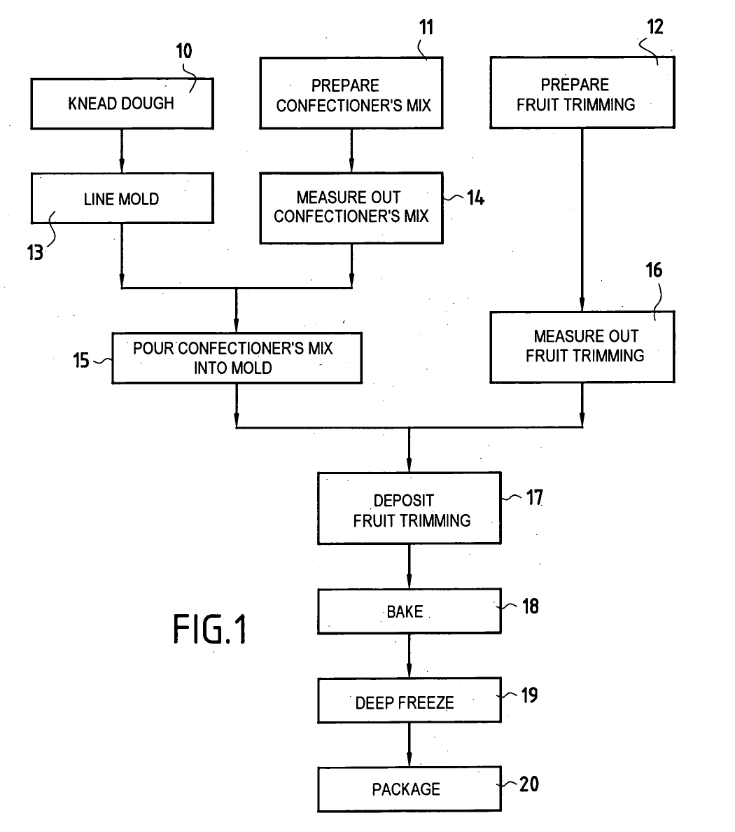

In the method of FIG. 1, the following actions are performed separately: a dough is kneaded (step 10); a confectioner's mix is prepared (step 11); and a fruit trimming is prepared (step 12).

The mold is lined with the previously-prepared dough (step 13) which may be a short crust pastry, a puff pastry, or a shortbread dough. The dough covers the bottom 32 of the mold and the walls 34, 35, 36, 37 over a fraction of their height, preferably lying in the range ¼th to ⅔rds said height, up from the bottom.

The confectioner's mix is an optionally-foamed creamy preparation, for example a confectionery filling or an almond cream. It is measured out (step 14) so as to cover the dough in the mold with a determined quantity of confectionery filling (step 15). As is well known, the confectionery filling absorbs juice from fruit during baking, thus enabling the pastry to remain crunchy.

The fruit trimming comprises fruit or pieces of fruit mixed with a gelling composition, which composition represents about 10% to 40% by weight relative to the weight of the fruit.

For example, a gelling composition is used containing brown sugar and/or pectin. Typically, the gelling composition comprises 25% to 35% by weight of eggs, 25% to 35% by weight of sugar (saccharose or other sugar), 25% to 35% by weight of butter or other optionally animal fat, and 2% to 10% by weight of a gelling ingredient such as pectin. Various kinds of fruit can be used, whole or in pieces, such as apples, pears, plums, apricots, peaches, red fruit, . . . .

As shown in FIG. 3, the fruit trimming can be measured out by a feeder 38 (step 16) so as to be deposited on the dough and the confectioner's mix in the mold (step 17). The fruit trimming covers the filling and the dough, and fills the mold 30, thus extending above the dough margins lining the bottom portions of the walls of the mold.

The assembly comprising the dough, the confectioner's mix, and the fruit trimming is baked (step 18) prior to being deep-frozen (step 19) and packaged (step 20). Naturally, the freezing step may be omitted depending on how soon the resulting pastry is to be eaten, and the pastry is advantageously kept in its mold.

After baking, a fruit pastry 50 (FIG. 4) is obtained in the form of a bar and comprising a baked pastry tartlet 52 having a rectangular bottom with longitudinal and end walls 54, 56, a confectioner's mix 58 filling the pastry tartlet, and a trimming 60 comprising fruit or pieces of fruit 62 held together by a gelled composition. The fruit or pieces of fruit penetrate into the layer of filling prior to baking. The pastry can be removed from the mold 30 while keeping its shape well.

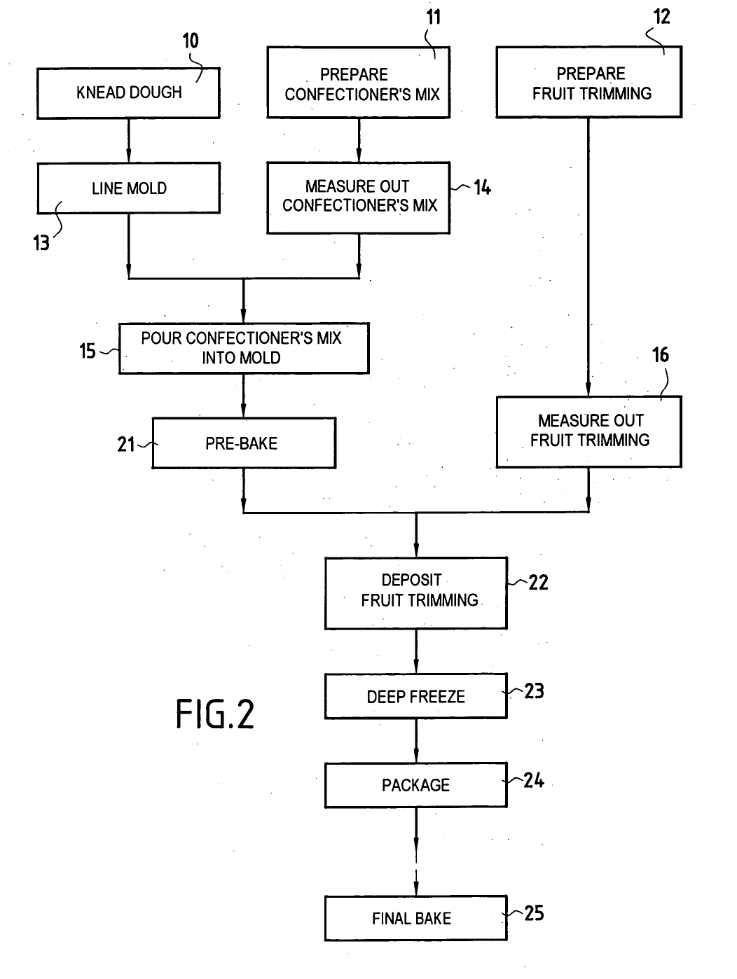

FIG. 2 shows another implementation of the invention that differs from that of FIG. 1 in that prior to depositing the fruit trimming, the dough and the confectioner's mix filling it in the mold 30 is subjected to a pre-baking step (step 21). Pre-baking is performed up to a level corresponding to 50% to 85% of complete baking, the level of pre-baking being measured in terms of degree of dehydration. The degree of pre-baking may vary as a function in particular of the nature of the fruit trimming that is to be added subsequently and that will be subjected to the final baking step.

Subsequently, the pre-baked pastry and confectioner's mix in the mold are covered with the measured quantity of fruit trimming (step 22.) so as to fill the mold 30.

The assembly comprising the pre-baked pastry and confectioner's mix together with the fruit trimming constitutes an intermediate product that can be stored cooled or deep-frozen (step 23) and packaged (step 24). Before consumption, a final baking step (step 25) is performed so as to complete baking.

It should be observed that the pre-baking may be performed after the fruit trimming has been deposited, and that the pre-baked pastry can then be deep-frozen.

### EXAMPLE

An apple bar was made as follows.

A card mold having a length of 150 millimeters (mm), a width of 30 mm, and a height of 30 mm was lined with about 40 grams (g) of dough covering the bottom of the mold and its walls up to a height of 15 mm.

The dough was filled with a 12 mm thick layer of almond cream. The cream had the following composition: 1 part by weight of butter, 1 part by weight of egg, 1 part by weight of sugar, 1 part by weight of almond powder, and 0.75 parts by weight of wheat flour.

The assembly was pre-baked up to a level corresponding to 75% of total baking, at a temperature of 180° C.

After pre-baking, the pastry and the confectioner's mix were filled by the feeder pouring about 90 g of trimming comprising pieces of apple and a gelling composition into the mold, said gelling composition representing 30% by weight relative to the weight of apple. The gelling composition was constituted by 1 part by weight of egg, 1 part by weight of sugar, 1 part by weight of butter, and 0.1 part by weight of a gelling ingredient (pectin).

The assembly was finally baked at a temperature of about 200° C.

After final baking, it was found that the pieces of fruit had taken on an attractive appearance and that the pastry held together perfectly well in spite of the low height of the pastry margins. The photograph of FIG. 5 shows the apple bar as obtained after being extracted from the mold.

As mentioned above, an intermediate product can be deep-frozen prior to depositing the fruit trimming, with final baking then being performed immediately before consumption.

It is also possible to omit the pre-baking step.

1. A method of making a fruit pastry in the form of a bar, the method being characterized in that it comprises the steps consisting in:
lining a mold of elongate shape and substantially U-shaped section with a pastry dough covering the bottom of the mold and its side walls over a fraction only of their height up from the bottom;
pouring a confectioner's mix onto the dough;
covering the dough and the confectioner's mix with a trimming of fruit or pieces of fruit mixed with a gelling composition by pouring the trimming into the mold up to the top thereof; and
baking the pastry and the covered confectioner's mix in the mold.

2. A method according to claim 1, characterized in that a confectioner's mix is used selected from an almond cream and a confectionery filling.

3. A method according to claim 1, characterized in that a gelling composition is used that contains brown sugar.

4. A method according to claim 1, characterized in that a gelling composition is used that contains a gelling ingredient.

5. A method according to claim 1, characterized in that a single-use mold is used made of a material selected in particular from aluminum and card.

6. A method according to claim 1, characterized in that the trimming of fruit or pieces of fruit is applied automatically by means of a feeder.

7. A method according to claim 1, characterized in that the mold is lined with the dough so as to cover the side walls of the mold up to a height lying in the range ¼th to ⅔rds the height of said walls.

8. A method according to claim 1, characterized in that the assembly comprising the baked pastry and confectioner's mix together with the trimming in the mold is deep-frozen.

9. A method according to claim 1, characterized in that the dough and the confectioner's mix are pre-baked so as to reach a level of baking that corresponds to 50% to 85% of complete baking.

10. A method according to claim 9, characterized in that the pre-baking is performed prior to filling with the trimming of fruit or pieces of fruit.

11. A method according to claim 9, characterized in that the assembly comprising the pre-baked pastry and confectioner's mix together with the optionally-pre-baked fruit trimming is deep-frozen.

12. A fruit pastry in the form of a bar, characterized in that it comprises a pastry tartlet having a rectangular bottom with longitudinal and end margins, a confectioner's mix filling the bottom of the tartlet, and fruit or pieces of fruit held together by a gelled composition forming a trimming covering the tartlet and rising to above the margins thereof, while substantially reproducing the outside rectangular profile of the tartlet.

13. A pastry according to claim 12, characterized in that it is packaged in its single-use baking mold, in particular a mold made of aluminum or card.

14. A pastry according to claim 13, characterized in that the pastry covers the side walls of the mold over a height lying in the range ¼th to ⅔rds the height of said walls, from the bottom of the mold.

15. A method according to claim 2, characterized in that a gelling composition is used that contains brown sugar.

16. A method according to claim 2, characterized in that a gelling composition is used that contains a gelling ingredient.

17. A method according to claim 3, characterized in that a gelling composition is used that contains a gelling ingredient.

18. A method according to claim 2, characterized in that a single-use mold is used made of a material selected in particular from aluminum and card.

19. A method according to claim 3, characterized in that a single-use mold is used made of a material selected in particular from aluminum and card.

20. A method according to claim 4, characterized in that a single-use mold is used made of a material selected in particular from aluminum and card.
